(19) United States
(12) Patent Application Publication
(10) Pub. No.: US 2013/0289148 A1
(43) Pub. Date: Oct. 31, 2013

(54) TOUGHENED POLYAMIDE COMPOSITIONS

(71) Applicant: E I DU PONT DE NEMOURS AND COMPANY, Wilmington, DE (US)

(72) Inventor: Avelino F. LIMA, North Hills, WV (US)

(73) Assignee: E I DU PONT DE NEMOURS AND COMPANY, Wilmington, DE (US)

(21) Appl. No.: 13/781,827

(22) Filed: Mar. 1, 2013

Related U.S. Application Data
(60) Provisional application No. 61/639,122, filed on Apr. 27, 2012.

(51) Int. Cl. C08L 77/06

(52) U.S. Cl. CPC C08L 77/06
USPC 521/92; 524/538; 521/134; 524/504; 521/140; 524/514; 524/387; 521/88; 524/80

(57) ABSTRACT

Disclosed is a thermoplastic resin composition including
a) a polyamide including repeat units of the formula

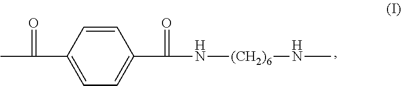

and repeat units of the formula

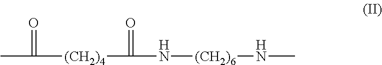

(b) a polymer toughener blend including b1) a polymeric toughener and b2) at least one nonfunctional polymeric toughener; wherein the polymer toughener blend has an averaged calculated acid number of about 5 to about 15 mg KOH/g before blending into the thermoplastic resin composition.

### CROSS REFERENCE TO RELATED APPLICATIONS

This application claims priority of U.S. Provisional Application 61/639,122, filed Apr. 27, 2012.

### FIELD OF THE INVENTION

Polyamides containing repeat units derived from 1,6-diaminohexane and terephthalic acid, and 1,6-diaminohexane and adipic acid, in specified proportions, may be toughened with exceptionally small amounts of rubber tougheners, to give compositions which are especially tough.

### TECHNICAL BACKGROUND

So-called “engineering polymers”, including polyamides, are important items of commerce, being used extensively for many different types of parts in for instance automotive, electrical and industrial uses. In some cases the polymers themselves are too brittle and so must be toughened. This is commonly achieved by mixing into the polyamide or other engineering polymer a “rubber toughener”, see for instance U.S. Pat. No. 4,174,358.

Toughness of such compositions is often measured by some standard test such as the Notched Charpy (ISO 179). Generally speaking the higher the values obtained in this test the tougher the material is considered. Similar to many property “improvements” to thermoplastic compositions, addition of the toughener often results in the diminution of other desirable properties, so tradeoffs in properties are usually made. For instance addition of the rubber toughener usually results in lowering of the tensile and flexural moduli and heat resistance of the compositions. Since this affects part stiffness, sometimes the parts have to be made larger to compensate for the loss in modulus, incurring an economic penalty. Therefore improved compositions containing toughened polyamides are desired. Especially desirable are thermoplastic resin compositions that have less toughener, and a minimum level of functionality, e.g. acid number, within the toughener.

U.S. Pat. No. 7,919,013 B2 discloses thermoplastic molding compositions comprising a semiaromatic polyamide, impact-modifying polymer, particulate fillers, lubricant, and electrically conductive filler.

U.S. Pat. No. 7,199,188 B2 discloses an impact modified polyamide composition including an ethylene maleic anhydride copolymer having at least 3% maleic anhydride functionality.

WO 2006/020402 A1 discloses an impact modified polyamide composition.

US 2005/0113532 A1 discloses high flow, toughened and weatherable compositions including polyamide resin, toughener, organic acid, and a stabilizer combination including an inorganic and organic stabilizer.

### SUMMARY OF THE INVENTION

Disclosed is a thermoplastic resin composition comprising
a) 42 to 96 weight percent by weight of a polyamide consisting essentially of 10 to 35 weight percent repeat units of the formula

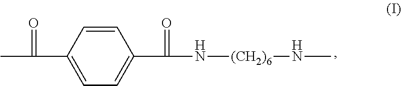

0 to 10 weight percent repeat units selected from the group consisting of the formula

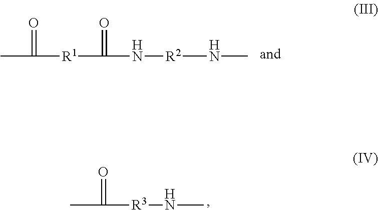

wherein R¹, R² and R³ are each independently hydrocarbylene or substituted hydrocarbylene, wherein R¹ is not 1,4-phenylene and/or R² is not —(CH₂)₆—,

and the remainder of the repeat units are of the formula

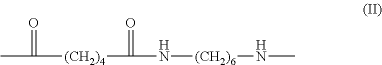

provided that each of (III) and (IV) are different than (I) and (II);
b) 4 to 30 weight percent of a polymer toughener blend, wherein said polymer toughener blend comprises b1) 25 to 75 wt % a polymeric toughener; and b2) 25 to 75 wt % at least one nonfunctional polymeric toughener; and wherein said polymer toughener blend has an averaged calculated acid number of about 5 to about 15 mg KOH/g before blending into said thermoplastic resin composition; and
c) 0 to 50 weight percent reinforcing agent;
d) 0 to 10 weight percent of additives selected from the group consisting of mold release, flow enhancers, thermal stabilizers, antistatic agents, blowing agents, lubricants, plasticizers, and colorant and pigments;
   wherein said weight percents are based on the total amount of (a), (b), (c) and (d) present in said composition, and said repeat unit weight percents are based on the total weight of formula (I), (II), (III) and (IV) present

Other embodiments include molded and/or shaped parts provided by injection molding, extrusion, thermoforming, compression molding, rotomolding or blow molding the thermoplastic resin compositions described herein.

### DETAILED DESCRIPTION

By “hydrocarbylene” is meant a group (radical) containing carbon and hydrogen having two free (single bond) valencies from two different carbon atoms. Exemplary hydrocarbylene groups include 1,10-decylene, 1,3-butylene, 2-methyl-1,5-pentylene, 1,4-phenylene, 1,8-naphthylene, 4,4′-biphenylene, and 1,3-phenylene.

By “substituted hydrocarbylene” is meant hydrocarbylene substituted with one or more functional groups that do not interfere with formation of the polyamide using the particular polyamide synthesis method chosen. Exemplary substituent groups include ether, halo, and tertiary amino.

The term “reactive functional group” means a group which normally reacts with a complimentary reactive group which is part of the polyamide, particularly during melt forming and/or melt processing of the polyamide composition. Typically the complimentary functional group on the polyamide is carboxyl and/or amino end groups, but may be other groups which are either grafted onto the polyamide or are originally polymerized into the polyamide as part of relatively small amounts of comonomers that contain the complimentary functional group. Typical reactive functional groups are epoxy, carboxyl, carboxylic anhydride, isocyanato, and keto. Preferred reactive functional groups are carboxyl, carboxylic anhydride, and epoxy.

The thermoplastic resin composition includes (a) 42 to 96 weight percent by weight of a polyamide consisting essentially of 10 to 35 weight percent repeat units of the formula

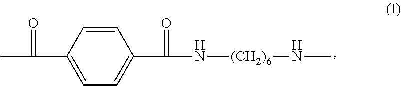

0 to 10 weight percent repeat units selected from the group consisting of the formula

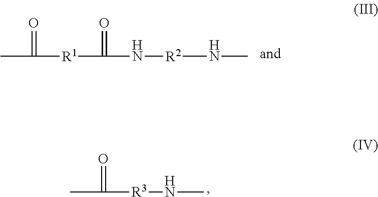

wherein R¹, R² and R³ are each independently hydrocarbylene or substituted hydrocarbylene, wherein R¹ is not 1,4-phenylene and/or R² is not —(CH₂)₆—,

and the remainder of the repeat units are of the formula

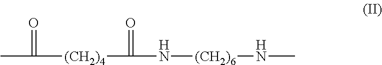

provided that each of (III) and (IV) are different than (I) and (II).

In the polyamide, formula (I) repeat unit is abbreviated 6T and formula (II) repeat unit is abbreviated 66. PA 66/6T is the abbreviation for a preferred polyamide having no formula (III) or (IV) repeat units.

In the polyamide the minimum amount of formula (I) repeat units is about 10, preferably about 15, more preferably about 20 weight percent, while the maximum amount of (I) repeat units is about 35, preferably about 30, more preferably about 28 weight percent. It is to be understood that any minimum value may be combined with any maximum value to form a preferred weight percent range.

The polyamide may contain up to about 10 weight percent one or more of repeat units of formula (III) and/or (IV). Preferably the polyamide contains up to about 5 weight percent of (III) and/or (IV), more preferably the polyamide consists essentially of 10 to 35 weight percent of repeat units (I) and 65 to 90 weight percent repeat units of formula (II), and, especially preferably, consists of repeat units (I) and (II) in the afore stated ranges.

The term “consists essentially of” herein refers to the property of toughening the thermoplastic resin composition using relatively small amounts of polymer toughener blends, for instance, 8 to 20 weight percent or 8 to 12 weight percent, based on the total weight of the thermoplastic resin composition. The polymer toughener blends have an averaged calculated acid number of about 5 to about 15 mg KOH/g before blending into a thermoplastic resin composition.

The polyamide may be made by methods well known in the art, see for instance M. I. Kohan Ed., Nylon Plastics Handbook, Hanser/Gardner Publications, Inc., Cincinnati, 1995, p. 17-23, which is hereby included by reference. Preferably the polyamide has a number average molecular weight of at least about 5,000, when measured by Gel Permeation Chromatography using polyethylene standards.

The thermoplastic resin composition includes (b) 8 to 30 weight percent, and preferably 8 to 25 weight percent, of a polymer toughener blend. Other embodiments include 8 to 20 weight percent and 8 to 12 weight percent of the polymer toughener blend. The polymer toughener blend provides a rubber phase in the thermoplastic resin composition. The polymer toughener blend comprises (b1) 25 to 75 wt % a polymeric toughener; and (b2) 25 to 75 wt % at least one nonfunctional polymeric toughener. The polymer toughener blend has an averaged calculated acid number of about 5 to about 15 mg KOH/g before blending into the thermoplastic resin composition.

The term “averaged calculated acid number” is determined by The averaged calculated acid number of the polymer toughener blend is determined by weight averaging the calculated acid number of the polymer toughener(s) and the non-functional polymer tougheners making up the polymer toughener blend.

For instance, the calculated acid number of a polymer toughener copolymer having 2 weight % of acrylic acid (AA) repeat units can be determined as follows:
2 wt % copolymer can be expressed as 0.02 g AA/g of copolymer;
0.02 g AA/72 g/mole AA=2.78×10⁴ mole AA; which can now be expressed as: 2.78×10⁴ mole AA/1 g of copolymer;
1 mole of KOH (MW 56) neutralizes 1 mole AA; therefore

(2.78×10⁴ mole AA/1 g of copolymer)×56 g/mol KOH×1000 mg/g=15.6 mg KOH/1 g copolymer.

Using similar calculations the following table can be constructed for various wt % acrylic acid copolymers:

| | Acid number (mg |
|---|---|
| Wt % AA | KOH/g copolymer |
| 0.5 | 3.9 |
| 1.0 | 7.8 |
| 2.0 | 15.6 |
| 4.0 | 31.2 |
| 8.0 | 62.8 |

The calculated acid number of a copolymer grafted with 2 weight % of maleic anhydride (MAH, MW 98) repeat units can be determined as follows:
2 wt % graft can be expressed as 0.02 g MAH/g of copolymer;
0.02 g MAH/98 g/mole MAH=2.04×10⁴ mole MAH; which can now be expressed as: 2.04×10⁴ mole MAH/1 g of copolymer;
2 mole of KOH (MW 56) neutralizes 1 mole MAH; therefore

(2.04×10⁴ mole MAH/1 g of copolymer)×56 g/mol KOH×1000 mg/g=22.9 mg KOH/1 copolymer.

| | Acid number (mg |
|---|---|
| Wt % MAH | KOH/g copolymer |
| 0.5 | 5.72 |
| 1.0 | 11.45 |
| 2.0 | 22.9 |
| 4.0 | 45.8 |
| 8.0 | 91.6 |

Other polymer tougheners can be calculated using similar method.

The weight fraction of each polymer toughener and nonfunctional polymer toughener making up the polymer toughener blend is determined based on the total weight of the polymer toughener blend. The summation of the weight fraction times the acid number calculated for each polymer toughener and the nonfunctional polymer toughener is the averaged calculated acid number for the polymer toughener blend. It should be noted that the acid number of non-functional polymer tougheners is by definition zero.

Herein the calculated acid number of the polymer toughener is based upon the nominal weight percent functionality of the polymer toughener based on the information provided by the manufacturer of the polymer toughener in the product specification. For example, an acrylic acid functionalized copolymer has a calculated acid number based upon the weight percent acrylic acid indicated in the manufacturer's product specification. A maleic anhydride modified polymer toughener has a calculated acid number based upon the weight percent maleic anhydride indicated in the manufacturer's product specification, times 2, as maleic anhydride provides two acid equivalents.

In another embodiment the acid number for the polymer toughener blend may be empirically determined by titration methods. For example, for acrylic acid functionalized copolymers ASTM D4094-07 method may be used to determine the acid number.

The polymeric toughener and nonfunctional polymeric toughener are polymers, preferably rubbers, having glass transition points below 25° C.; and preferably below 0° C. The polymeric toughener and nonfunctional polymeric toughener preferably have melting points of less than 80° C., more preferably less than about 60° C., and have a heat of melting of less than about 10 J/g, more preferably less than about 5 J/g, as measured by ASTM Method D3418-82. Other useful polymeric tougheners and nonfunctional polymeric tougheners have no melting point. Preferably the polymeric toughener and nonfunctional polymeric toughener have a weight average molecular weight of about 5,000 or more, more preferably about 10,000 or more, when measured by size exclusion chromatography using polyethylene standards.

The polymeric toughener is a polymer, typically which is an elastomer or has a relatively low melting point, generally less than 200° C., which has attached to it reactive functional groups which can react with the polyamide. Such functional groups are usually “attached” to the polymeric toughener by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber, such as an ethylene/α-olefin copolymer, an α-olefin being a straight chain olefin with a terminal double bond such a propylene or 1-octene, using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group. By (meth)acrylate herein is meant the compound may be either an acrylate, a methacrylate, or a mixture of the two. Useful (meth)acrylate functional compounds include (meth)acrylic acid, 2-hydroxyethyl(meth)acrylate, glycidyl(meth)acrylate, and 2-isocyanatoethyl (meth)acrylate. In addition to ethylene and a difunctional (meth)acrylate monomer, other monomers may be copolymerized into such a polymer, such as vinyl acetate, unfunctionalized (meth)acrylate esters such as ethyl (meth)acrylate, n-butyl (meth)acrylate, i-butyl (meth)acrylate and cyclohexyl (meth)acrylate. Preferred tougheners include those listed in U.S. Pat. No. 4,174,358, which is hereby included by reference. Other preferred polymeric tougheners are copolymers of ethylene, ethyl acrylate or n-butyl acrylate, and glycidyl methacrylate.

Another type of reactive functional group which may be attached to a polymer to provide a polymeric toughener is a metal salt of a carboxylic acid, Such polymeric tougheners are often referred to as ionomers. Such polymers may be made by grafting or by copolymerizing a carboxyl or carboxylic anhydride containing compound to attach it to the polymer, followed by neutralization of the carboxylic acid or anhydride groups, for instance, with metal hydroxides. Useful materials of this sort include Surlyn® ionomers available from E. I. DuPont de Nemours & Co. Inc., Wilmington, Del. 19898 USA, and the metal neutralized maleic anhydride grafted ethylene/α-olefin polymer described above. Preferred metal cations for these carboxylate salts include Zn, Li, Mg and Mn.

It is preferred that the polymeric toughener contain a minimum of about 0.5, and more preferably, 1.0 weight percent of repeat units and/or grafted molecules containing functional groups or carboxylate salts (including the metal), and a maximum of about 15, more preferably about 13, and very preferably about 10 weight percent of monomers containing functional groups or carboxylate salts (including the metal). It is to be understood than any preferred minimum amount may be combined with any preferred maximum amount to form a preferred range. There may be more than one type of functional monomer present in the polymeric toughener, and/or more than one polymeric toughener.

Preferred polymeric tougheners of b1 are selected from the group consisting of:
(b11) an ethylene/α-olefin or ethylene/α-olefin/diene (EPDM) copolymer grafted with an unsaturated carboxylic anhydride such as maleic anhydride.
(b12) a copolymer of ethylene, 2-isocyanatoethyl (meth)acrylate, and optionally one or more (meth)acrylate esters.
(b13) a copolymer of ethylene and acrylic acid reacted with a Zn, Li, Mg or Mn compound to form the corresponding ionomer, and
(b14) a block polymer consisting of styrene-ethylene/butylene-styrene triblock polymer functionalized with maleic anhydride; for instance, Kraton®FG1901 elastomer, available from Kraton Polymers, Inc.

The nonfunctional polymeric tougheners (elastomers) present in the polymer toughener blend include polymers selected from the group consisting of ethylene/α-olefin/diene (EPDM) rubber, ethylene/α-olefin (EP) rubber, ethylene/1-octene copolymers, ethylene/butene copolymers, and styrene-ethylene/α-olefin-styrene block copolymers.

Preferred nonfunctional polymeric tougheners of b2 are selected from the group consisting of:
(b21) an ethylene/α-olefin or ethylene/α-olefin/diene (EPDM) copolymer; and
(b22) a block polymer consisting of styrene-ethylene/butylene-styrene triblock polymer, for instance, Kraton® G1657 elastomer.

The thermoplastic resin composition may comprise 0 to 50 weight percent, of one or more reinforcement agents. In one embodiment the thermoplastic composition comprises 10 to 50 weight percent reinforcing agent. In another embodiment the thermoplastic composition has no reinforcement agent. The reinforcement agent may be any filler, but is preferably selected from the group consisting of calcium carbonate, glass fibers with circular cross-section, glass fibers with noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof. Glass fibers, glass flakes, talc, and mica are preferred reinforcement agents.

The thermoplastic composition may comprise 0 to 10 weight percent of additives selected from the group consisting of thermal stabilizers, mold release agents, flow enhancers, antistatic agents, blowing agents, lubricants, plasticizers, and colorant and pigments.

The thermoplastic resin composition may comprise 0 to 10 weight percent, and preferably 0.1 to 10 weight percent, of one or more polyhydric alcohols having more than two hydroxyl groups and having a number average molecular weight (Mₙ) of less than 2000 of less than 2000 as determined for polymeric materials with gel permeation chromatography (GPC)

Polyhydric alcohols may be selected from aliphatic hydroxylic compounds containing more than two hydroxyl groups, aliphatic-cycloaliphatic compounds containing more than two hydroxyl groups, cycloaliphatic compounds containing more than two hydroxyl groups, aromatic and saccharides.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the polyhydric alcohol used in the thermoplastic composition is pentaerythritol, dipentaerythritol, tripentaerythritol, di-trimethylolpropane, D-mannitol, D-sorbitol and xylitol. More preferably, the polyhydric alcohol used is dipentaerythritol and/or tripentaerythritol. A most preferred polyhydric alcohol is dipentaerythritol (DPE).

In various embodiments the content of said polyhydric alcohol in the thermoplastic resin composition is 0.25 to 10 weight percent, preferably 0.25 to 8 weight percent, and more preferably 0.25 to 6 weight percent, and 1 to 6 weight percent.

The thermoplastic resin composition may comprise 0.1 to 10 weight percent of at least one polyhydroxy polymer having a number average molecular weight (Mₙ) of at least 2000, selected from the group consisting of ethylene/vinyl alcohol copolymer and poly(vinyl alcohol); as determined for polymeric materials with gel permeation chromatography (GPC). Preferably the polyhydroxy polymer has a Mₙ of 5000 to 50,000.

In one embodiment the polyhydroxy polymer is an ethylene/vinyl alcohol copolymer (EVOH). The EVOH may have a vinyl alcohol repeat content of 10 to 90 mol % and preferably 30 to 80 mol %, 40 to 75 mol %, 50 to 75 mol %, and 50 to 60 mol %, wherein the remainder mol % is ethylene. A suitable EVOH for the thermoplastic composition is Soamol® A or D copolymer available from Nippon Gosei (Tokyo, Japan) and EVAL® copolymers available from Kuraray, Tokyo, Japan.

The thermoplastic resin composition may comprise about 0.1 to at or about 1 weight percent, or more preferably from at or about 0.1 to at or about 0.7 weight percent, based on the total weight of the polyamide composition, of copper salts. Copper halides are mainly used, for example CuI, CuBr, Cu acetate and Cu naphthenate. Cu halides in combination with alkali halides such as KI, KBr or LiBr may be used. Copper salts in combination with at least one other stabilizer selected from the group consisting of poyhydric alcohols, polyhric polymers, secondary aryl amines and hindered amine light stabilizers (HALS); may be used as thermal stabilizers.

Lubricants useful in the thermoplastic resin compositions include metal salts of higher fatty acid with an acid number of 0.5 mg KOH/g or less, such as aluminum distearate, and higher fatty acid amides, for instance, N,N′-ethylene bisstearamide.

The thermoplastic resin composition may be made by methods known in the art for making “rubber” toughened thermoplastic compositions. Typically the polyamide is melt mixed with the polymeric toughener in a suitable device such as a twin screw extruder or a kneader. During the melt mixing described above other ingredients, as described above may also be added to the polyamide and polymeric toughener blend being mixed. They may be added at the rear of the mixing apparatus, or somewhere downstream of that to prevent their being degraded by excessive shear.

The toughened polyamide compositions described herein may be molded into shaped parts by a variety of methods, usually melt forming methods, such as injection molding, extrusion, thermoforming, compression molding, rotomolding, and blow molding (of all types). These parts are useful in automotive, industrial, electrical and electronic, and consumer applications. Exemplary applications include cable ties, sporting goods such as snow boards, fire extinguisher valves, automotive parts such as emission canisters and roof racks, power tool housings, and appliance components such as impeller fans and bag clips.

### Methods

### Compounding and Molding Methods

The compositions listed in Table 1 were fed to the rear of a 40 mm co-rotating twin screw extruder fitted with a moderately hard working screw run at 300-330 rpms with a 200 lb/hr feed rate; with the exception that components designated as “side fed” in Table 1 were added at barrel #6 of the extruder. The barrel temperature was set at 280° C. The hand melt temperature for Examples 1, 2, 3, and 4 were respectively. 296, 302, 296, 302° C. and hand melt temperature for comparative examples C1, C2, C3, C4, and C5 were 293, 290, 307, 310, and 326° C., respectively.

### Sample Preparation and Physical Testing

The compositions were pelletized after exiting the extruder. After drying pellets overnight using a nitrogen bleed, the pellets were injection molded in a Demag #2 injection molding machine at a melt temperature of 287-293° C. and a mold temperature of 77-83° C. to provide 4 mm ISO all-purpose bars. The bars were vacuum sealed in a foil lined plastic bag to preserve them in the dry-as-molded (DAM) condition until they were cut and after conditioning in accordance with ISO 179 Method, specimens were tested for Notched Charpy at 23° C., 0° C., and minus 40° C. (ISO method 179).

Tensile strength, elongation at break, and tensile modulus were tested dry as molded on a tensile tester by ISO 527-1/-2 at 23° C. and strain rate of 50 mm/min at room temperature.

### Kayness Melt Viscosity

Melt viscosity (MV) was measured using a Kayeness rheometer. The melt viscosities of the pellets obtained were measured at a shear rate of 1000/second and at a temperature of 280° C. after a residence time of 5 min in each example.

### Acid Number Calculation

The calculated acid number was based on the nominal amount of anhydride or acid functionality copolymerized and/or grafted to the polymer toughener, per the manufacturers product specification.

### Materials

PA66 refers to an aliphatic polyamide made of 1,6-hexanedioic acid and 1,6-hexamethylenediamine having an relative viscosity in the range of 46-51 and a melting point of about 263° C., commercially available from E.I. DuPont de Nemours and Company, Wilmington, Del., USA under the trademark Zytel® 101NC010.

PA66/6T (75/25 molar ratio repeat units) with amine ends approximately 80 meq/kg, having a typical relative viscosity (RV) of 41, according to ASTM D-789 method, and a typical melt point of 268° C., was provided according to the following procedure:

Polyamide 66 salt solution (3928 lbs. of a 51.7 percent by weight with a pH of 8.1) and 2926 lbs of a 25.2% by weight of polyamide 6T salt solution with a pH of 7.6 were charged into an autoclave with 100 g of a conventional antifoam agent, 20 g of sodium hypophosphite, 220 g of sodium bicarbonate, 2476 g of 80% HMD solution in water, and 1584 g of glacial acetic. The solution was then heated while the pressure was allowed to rise to 265 psia at which point, steam was vented to maintain the pressure at 265 psia and heating was continued until the temperature of the batch reached 250° C. The pressure was then reduced slowly to 6 psia, while the batch temperature was allowed to further rise to 280-290° C. The pressure was then held at 6 psia and the temperature was held at 280-290° C. for 20 minutes. Finally, the polymer melt was extruded into strands, cooled, and cut into pellets.

TRX®301 copolymer refers to a maleic anhydride modified EPDM from available from E.I. DuPont de Nemours and Company, Wilmington, Del., USA.

Engage® 8180 copolymer is an ethylene/octene copolymer from Dow Chemical, Houston, Tex., USA.

Additive package refers to a blend containing 70 wt % dodecanedioic acid and 30 wt % Cu heat stabilizer; the Cu heat stabilizer consisting of a mixture of 7 parts of potassium iodide and 1 part of copper iodide in 0.5 part of a stearate wax binder.

DPE refers to dipentaerythritol that was from Perstorp Specialty Chemicals AB, Perstorp, Sweden as Di-Penta 93.

Aluminum distearate is a wax supplied by PMC Global, Inc. Sun Valley, Calif., USA.

### EXAMPLES

Examples 1-4 illustrate the improved Notched Charpy exhibited in PA 66/6T at low acid numbers of the polymer toughener blend as compared to similar composition prepared with PA 66 (C1-C2).

Comparative Examples C4-C5 illustrate that PA 66/6T at higher acid numbers of the polymer toughener blend (e.g. 22.9 mg KOH/g) show no improvement in Notched Charpy versus a similar composition having PA 66 (C3).

TABLE 1

| | Examples | | | | | | | | |
|---|---|---|---|---|---|---|---|---|---|
| | C1 | C2 | C3 | 1 | 2 | C4 | 3 | 4 | C5 |
| Material | | | | | | | | | |
| PA 66 | 68.97 | 68.97 | 68.97 | | | | | | |
| PA 66 (side fed) | 20 | 20 | 20 | | | | | | |
| PA 66/6T | | | | 68.4 | 68.4 | 68.4 | 66.9 | 66.9 | 66.9 |
| PA 66/6T (side fed) | | | | 20 | 20 | 20 | 20 | 20 | 20 |
| Engage ® 8180 | 7 | 3.5 | | 7 | 3.5 | | 7 | 3.5 | |
| TRX ®301 | 3 | 6.5 | 10 | 3 | 6.5 | 10 | 3 | 6.5 | 10 |
| Additive package | 0.93 | 0.93 | 0.93 | | | | | | |
| DPE | | | | 1.5 | 1.5 | 1.5 | 3 | 3 | 3 |
| Aluminum Distearate | 0.1 | 0.1 | 0.1 | 0.1 | 0.1 | 0.1 | 0.1 | 0.1 | 0.1 |
| Physical Properties | | | | | | | | | |
| Notched Charpy at 23° C., (KJ/m²) | 14.3 | 16.3 | 21 | 17.6 | 19.1 | 18.2 | 15.6 | 17.9 | 17.6 |
| Notched Charpy at 0° C., (KJ/m²) | 12.7 | 15.0 | 18.0 | 15.8 | 16.4 | 16.2 | 14.9 | 15.5 | 14.7 |
| Notched Charpy at −40° C., (KJ/m²) | 9.2 | 10.0 | 12.9 | 11.5 | 12.0 | 10.7 | 9.8 | 11.0 | 10.5 |
| Kayness Melt Viscosity (Pas · sec) | 33 | 65 | 65 | 91 | 88 | 106 | 72 | 73 | 55 |
| Acid Number (mg KOH/g copolymer) - | 6.9 | 14.9 | 22.9 | 6.9 | 14.9 | 22.9 | 6.9 | 14.9 | 22.9 |
| Rubber phase | | | | | | | | | |
| Tensile Strength at Yield, (MPa) | 69 | 67 | 62 | 63 | 61 | 57 | 64 | 60 | 56 |
| Elongation at yield, 50 mm/min, (%) | 4.7 | 4.6 | 5.3 | 5.6 | 5.6 | 6.2 | 4.7 | 4.8 | 14.2 |

1. A thermoplastic resin composition comprising
a) 42 to 96 weight percent by weight of a polyamide consisting essentially of 10 to 35 weight percent repeat units of the formula 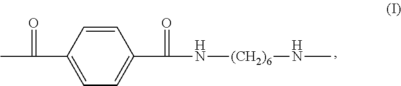
0 to 10 weight percent repeat units selected from the group consisting of the formula 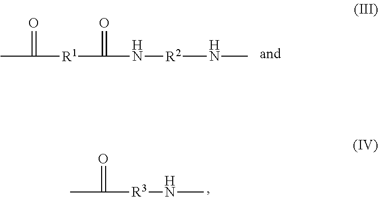
wherein R¹, R² and R³ are each independently hydrocarbylene or substituted hydrocarbylene, wherein R¹ is not 1,4-phenylene and/or R² is not —(CH₂)₆—,
and the remainder of the repeat units are of the formula 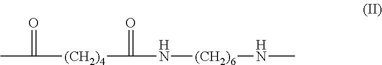
provided that each of (III) and (IV) are different than (I) and (II);
b) 4 to 30 weight percent of a polymer toughener blend, wherein said polymer toughener blend comprises b1) 25 to 75 wt % a polymeric toughener; and b2) 25 to 75 wt % at least one nonfunctional polymeric toughener; and wherein said polymer toughener blend has an averaged calculated acid number of about 5 to about 15 mg KOH/g before blending into said thermoplastic resin composition; and
c) 0 to 50 weight percent reinforcing agent;
d) 0 to 10 weight percent of additives selected from the group consisting of mold release, flow enhancers, thermal stabilizers, antistatic agents, blowing agents, lubricants, plasticizers, and colorant and pigments;
wherein said weight percents are based on the total amount of (a), (b), (c) and (d) present in said composition, and said repeat unit weight percents are based on the total weight of formula (I), (II), (III) and (IV) present.

2. The thermoplastic resin composition of claim 1 wherein said polyamide consists essentially of 10 to 35 weight percent repeat units of the formula (I) and 65 to 90 weight percent repeat unit of the formula (II).

3. The thermoplastic resin composition of claim 1 wherein said polymeric toughener b1 is selected from the group consisting of:
(b11) an ethylene/α-olefin or ethylene/α-olefin/diene (EPDM) copolymer grafted with an unsaturated carboxylic anhydride; (b12) a copolymer of ethylene, 2-isocyanatoethyl (meth)acrylate, and optionally one or more (meth)acrylate esters; (b13) a copolymer of ethylene and acrylic acid reacted with a Zn, Li, Mg or Mn compound to form a corresponding ionomer; and (b14) a block polymer consisting of styrene-ethylene/butylene-styrene triblock polymer functionalized with maleic anhydride.

4. The thermoplastic resin composition of claim 1 wherein said nonfunctional polymeric toughener of b2 are selected from the group consisting of: (b21) an ethylene/α-olefin or ethylene/α-olefin/diene (EPDM) copolymer; and (b22) a block polymer consisting of styrene-ethylene/butylene-styrene triblock polymer.

5. The thermoplastic resin composition of claim 1 wherein said additives comprise 1 to 6 weight percent polyhydric alcohol.

6. The thermoplastic resin composition of claim 1 wherein said additives comprise 0.1 to at or about 1 weight percent of copper salts.
